(19) United States
(12) Patent Application Publication
(10) Pub. No.: US 2021/0216982 A1
(43) Pub. Date: Jul. 15, 2021

(54) CONVERGED PAYMENT CREDENTIAL

(71) Applicant: Idemia Identity & Security USA LLC, Billerica, MA (US)

(72) Inventors: Stephen Miu, Chelmsford, MA (US); Yecheng Wu, Lexington, MA (US); Daoshen Bi, Boxborough, MA (US)

(21) Appl. No.: 17/149,935

(22) Filed: Jan. 15, 2021

Related U.S. Application Data
(60) Provisional application No. 62/961,528, filed on Jan. 15, 2020.

(51) Int. Cl. G06Q 20/10; G06Q 20/34; H04L 9/08

(52) U.S. Cl. CPC G06Q 20/105; H04L 9/0819; G06Q 20/341; G06Q 20/357

(57) ABSTRACT

A physical credential includes a first core stock layer provisioned in accordance with a first architecture defining an arrangement of embedded identity attributes with respect to X-Y coordinates of the physical credential. An inlay card layer is affixed to the first core stock layer and includes one or more wire-based antennas. A core stock layer is affixed to the inlay card layer and provisioned in accordance with a second architecture defining an arrangement of embedded security attributes with respect to the X-Y coordinates. The second architecture defines one or more constraints with the first architecture with respect to the X-Y coordinates. The core stock layer includes a semiconductor chip electrically coupled to the one or more wire-based antennas. A personalization layer is affixed to the core stock layer and includes one or more of the identity attributes embedded in compliance with the first architecture and the second architecture.

### CROSS-REFERENCE TO RELATED APPLICATION

This application claims priority to U.S. Application Ser. No. 62/961,528, filed on Jan. 15, 2020, which is incorporated in its entirety herein.

### FIELD OF THE INVENTION

This description relates generally to security improvement and specifically to converged payment credentials.

### BACKGROUND

An identification document can be used by an individual to assert their identity. In addition, an individual can use a separate payment document linked to a financial institution to make payments for good or services. However, the increasing number of entities and organizations requiring separate or unique identification and payment documents increases physical storage burdens on the individual. Moreover, identification documents and payment documents are often produced using multiple, conflicting standards.

### SUMMARY

In one aspect, a converged physical credential is disclosed. The physical credential includes a first core stock layer provisioned in accordance with a first architecture defining an arrangement of embedded identity attributes with respect to X-Y coordinates of the physical credential. An inlay card layer is affixed to the first core stock layer and includes one or more wire-based antennas. A second core stock layer is affixed to the inlay card layer and provisioned in accordance with a second architecture defining an arrangement of embedded security attributes with respect to the X-Y coordinates. The second architecture defines one or more constraints with the first architecture with respect to the X-Y coordinates. The second core stock layer includes a semiconductor chip electrically coupled to the one or more wire-based antennas. A personalization layer is affixed to the second core stock layer and includes one or more of the identity attributes embedded in compliance with the first architecture and the second architecture. One or more of the security attributes are embedded in compliance with the first architecture and the second architecture, such that the one or more constraints with respect to the X-Y coordinates are met.

In another aspect, a physical credential includes a core stock layer conforming to an identity card standard. The identity card standard specifies a first architecture defining an arrangement of embedded identity attributes in accordance with X-Y coordinates of the physical credential. The core stock layer includes one or more wire-based antennas machined into the core stock layer and configured to transmit one or more of the identity attributes to a credential reader. One or more security attributes are embedded in the core stock layer in compliance with a payment card standard. The payment card standard specifies a second architecture defining an arrangement of embedded security attributes in accordance with the X-Y coordinates. A personalization layer is affixed to the core stock layer and stores a digitized version of the one or more of the identity attributes in compliance with the identity card standard, such that one or more constraints defined by the second architecture with respect to the X-Y coordinates are met.

In another aspect, a method of manufacturing a physical credential includes provisioning a first core stock layer in accordance with a first architecture defining an arrangement of embedded identity attributes with respect to X-Y coordinates of the physical credential. An inlay card layer is affixed to the first core stock layer. The inlay card layer includes one or more wire-based antennas. A core stock layer is affixed to the inlay card layer in accordance with a second architecture defining an arrangement of embedded security attributes with respect to the X-Y coordinates. The second architecture defines one or more constraints with the first architecture with respect to the X-Y coordinates. The core stock layer includes a semiconductor chip electrically coupled to the one or more wire-based antennas. A personalization layer is affixed to the core stock layer. The personalization layer includes one or more of the identity attributes embedded in compliance with the first architecture and the second architecture. One or more of the security attributes are embedded in compliance with the first architecture and the second architecture, such that the one or more constraints with respect to the X-Y coordinates are met.

In another aspect, a digital credential includes a non-transitory computer-readable storage medium storing cryptographically-encoded data configured to be verifiable by at least one computer processor. The data includes a credential identifier specifying at least one of an issuing authority of the digital credential, an expiry date and time of the digital credential, a plurality of converged types of the digital credential, or a cryptographic key. The data includes multiple digital identity tokens, where each digital identity token stores one or more digitized attributes of a subject of the digital credential. The data includes multiple cryptographic keys, where each cryptographic key corresponds to a respective digital identity token. Each cryptographic key is for cryptographic verification of the respective digital identity token by the at least one computer processor.

Among other benefits and advantages, the embodiments disclosed herein provide converged credentials that integrate card technologies and manufacturing methods. One or more of the Europay, Mastercard, and Visa Consortium (EMVco) payment card standard, the American Association of Motor Vehicle Administrators (AAMVA) identity card standard, the International Standardization Organization (ISO)/International Electrotechnical Commission (IEC) 7810 standard for identification cards, or the Payment Card Industry Data Security Standard (PCI DSS) requirements can be combined into a single form factor, thus improving ease-of-use for a cardholder and reducing manufacturing or procurement costs. The benefits and advantages of the digital credentials disclosed herein include the use of cryptographic tokens that can prove user identity more anonymously than traditional methods. Hence, digital credentials provide a more privacy-friendly alternative to using large, centralized user records. The digital credentials disclosed herein can identify and authenticate signatories and subjects, and collect data that can later serve as evidence. They also allow obtaining an audit trail. A more agile workflow is provided because multiple secure signatures and proofs of credentialing can be obtained in less time, streamlining administrative and legal processes.

These and other aspects, features, and implementations can be expressed as methods, apparatus, systems, components, program products, means or steps for performing a function, and in other ways.

These and other aspects, features, and implementations will become apparent from the following descriptions, including the claims.

### BRIEF DESCRIPTION OF THE DRAWINGS

FIG. 1 illustrates an example converged physical credential, in accordance with one or more embodiments.

FIG. 2 illustrates multiple zones of an example identity card standard, in accordance with one or more embodiments.

FIG. 3 illustrates elements of an example architecture defining an arrangement of embedded security attributes specified by an example payment card standard, in accordance with one or more embodiments.

FIG. 4 illustrates an example national identity card converged with an example payment standard for transactions, in accordance with one or more embodiments.

FIG. 5 illustrates an example physical credential comprising a metal core stock layer, in accordance with one or more embodiments.

FIG. 6 illustrates an example surface treatment implemented on a metal core stock layer, in accordance with one or more embodiments.

FIG. 7 illustrates a portion of an example manufactured physical credential, in accordance with one or more embodiments.

FIG. 8 illustrates a flowchart of an example process for manufacturing a converged physical credential, in accordance with one or more embodiments.

### DETAILED DESCRIPTION

The embodiments disclosed herein provide multi-function, multi-purpose, secure, converged-technology payment and identity credentials.

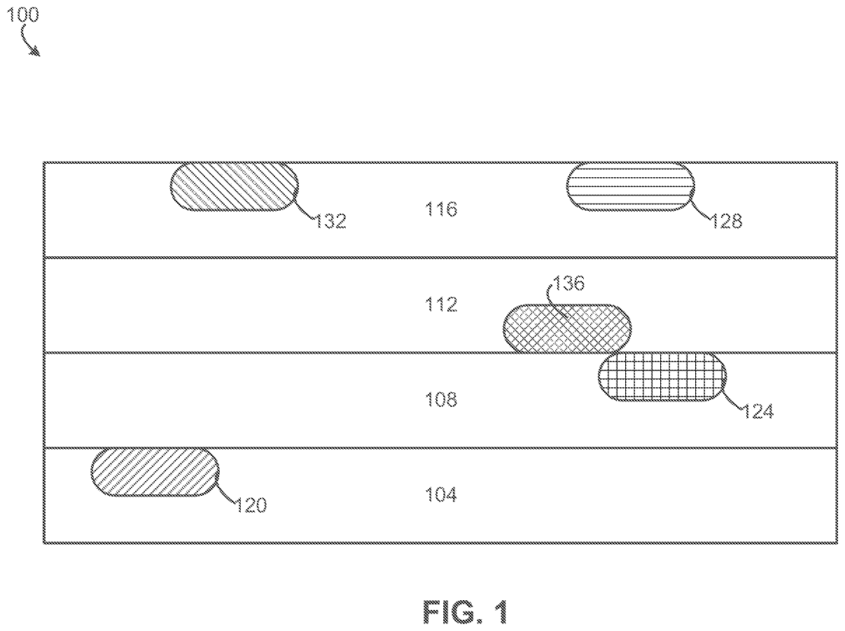

FIG. 1 illustrates an example converged physical credential 100, in accordance with one or more embodiments. The physical credential 100 includes a core stock layer 104. The core stock layer is sometimes referred to as a “substrate.” In some embodiments, the physical credential 100 is manufactured to include the core stock layer 104 provisioned in accordance with a first architecture defining an arrangement of embedded identity attributes 132 with respect to X-Y coordinates of the physical credential 100. The identity attributes 132 can be embedded in the core stock layer 104 or in any of the other layers 108, 112, 116 of the physical credential 100 shown in FIG. 1. For example, the identity attributes 132 are shown embedded in a personalization layer 116 in FIG. 1. The identity attributes 132 are embedded in compliance with the first architecture. The physical credential 100 is sometimes referred to as a “Europay, Mastercard, and Visa Consortium (EMVco)/American Association of Motor Vehicle Administrators (AAMVA) converged card” or a “metal core and dense polymer laminate identity credential.”

The core stock layer 104 can include polycarbonate, TESLIN, metal, plastic, ceramic, rubber, synthetic paper, polypropylene film, poly olefin, polyester, polyethylene terephthalate, or polyvinyl chloride. TESLIN refers to a proprietary, waterproof, synthetic printing medium having a single-layer, uncoated film. When the core stock layer 104 is made of metal, the physical credential 100 can be etched or patterned prior to subsequent personalization or lamination using polyester or newer materials. In some embodiments, a vision system is used to “see-through” certain materials using particular wavelengths of light. In other embodiments, an acquisition head of a credential verification system is adjusted to scan a metal surface (to authenticate the physical credential 100) using a particular frequency and wavelength of light to “see through” the laminations and use “skin texture analysis” in order to authenticate the core stock layer 104. The acquisition head refers to a scanning, input, or photographic mechanism of the credential verification system that senses the credential 100.

The surfaces or edges of the core stock layer 104 can be personalized to add identity attributes 132 relevant to the purposes of the physical credential 100, e.g., payment account information in the form of digital representations of data stored in a semiconductor chip 136. In some embodiments, security attributes 128 are embedded by printing and/or personalization of enhanced security features (ESF). An ESF refers to an authenticating technology feature that is included in a credential to enable identification document (ID) verification and multifactor authentication. Using ESFs, a government-issued document, for example, can be verified or authenticated in a matter of seconds using advanced image capture, machine learning, or computer vision techniques. In some embodiments, the ESFs are digitally encoded on any one or more of the layers 104, 108, 112, 116. The ESFs can be scanned by an optical machine (e.g., part of a credential verification or authentication system) to decipher the ESFs.

The physical credential 100 disclosed herein can be used for four or more different functions (sometimes generically referred to as “identity proofing”). The functions are performed using at least the security attributes 128 and the identity attributes 132. For example, a first function the physical credential 100 can be used for is “credential authentication.” Credential authentication refers to ensuring that the physical credential 100 is “real” and genuinely issued by a specified jurisdiction or authorizing entity (e.g., a bank). A second function the physical credential 100 can be used for is “credential verification.” Credential verification refers to determining whether a record of the asserted physical credential 100 exists in a specified system of record (e.g., a bank or government database). A third function the physical credential 100 can be used for is “identity verification” or “data verification.” Identity verification or data verification refers to determining whether the data in the system of record is consistent with the data stored on the asserted physical credential 100. For example, data verification can refer to achieving a 1-to-1 biometric match. If the biometric data is tied in the system of record to an individually identifiable record, then identity verification is achieved.

A fourth function the physical credential 100 can be used for is “credential validation.” Credential validation refers to determining whether the physical credential 100 is still “in force,” i.e., are the endorsements or privileges of the physical credential 100 still “valid” (unexpired or unrevoked). For example, when a driver's license is suspended, it may be downgraded to a state identity document. The state identity document is authentic, but the driving privilege is revoked and hence not valid. The embodiments disclosed herein can first be used to authenticate the physical credential 100, i.e., confirm that the physical credential 100 is “real” and not a fake. Second, a comparison of the authenticated personally identifiable information (PII) on the front and back of the physical credential 100 can confirm or verify that the data is “correct” as well because the physical credential 100 is real and so the data is correct. Third, a secondary or optional check in a government system of record can verify that the PII on this genuinely-issued physical credential 100 is in fact the latest and most current data on record. Fourth, after the data is verified to be the latest, and the physical credential 100 is determined to be in-force, credential validity can be confirmed.

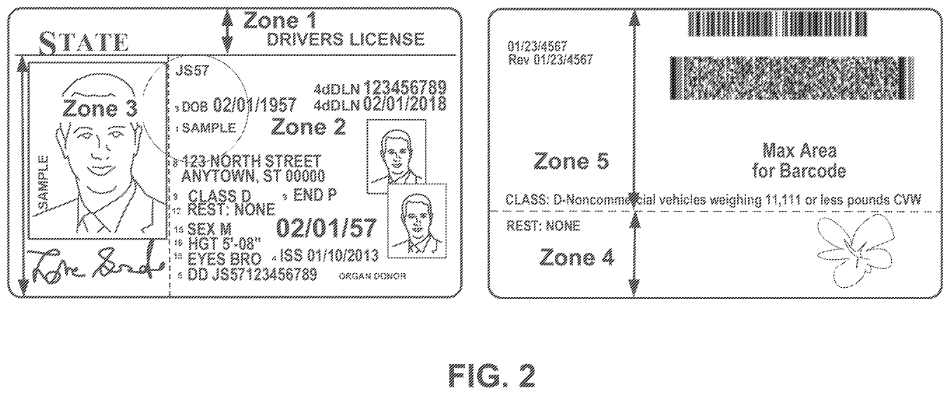

In some embodiments, the core stock layer 104 conforms to an identity card standard, for example, AAMVA or the International Standardization Organization (ISO)/International Electrotechnical Commission (IEC) 7810 standard for identification cards. The ISO/IEC 7810 standard specifies the physical characteristics for identification cards. The identity card standard conformed to herein specifies a first architecture defining an arrangement of embedded identity attributes 132 in accordance with X-Y coordinates of the physical credential 100. For example, the identity card standard and the first architecture can specify that a semiconductor chip can be embedded only within a particular zone defined by particular values of the X-Y coordinates of the physical credential 100. An example first architecture for an identity card standard, e.g., the AAMVA standard, is illustrated and described in more detail with reference to FIG. 2.

The identity attributes 132 can include a constrained code attribute, a barcode, a photograph, a magnetic stripe, a radio frequency identifier, a fluorescent overlay, a hologram, microtext, or laser engraving. Constrained code attributes refer to a set of constraints set on the feasible solutions for a set of decision variables of the physical credential 100. The constraints are monitored by a credential verification system by solving a combinatorial problem defined by the constraints for authenticating the physical credential 100. The physical credential 100 thus can contain information such as a photographic image, a bar code (which may contain information specific to the person whose image appears in the photographic image, and/or information that is the same from document to document), or variable personal information (such as an address, signature, and/or birthdate). The physical credential 100 can include biometric information associated with the person whose image appears in the photographic image. The biometric information can include a fingerprint. The physical credential 100 can include a magnetic stripe (which, for example, can be on the side of the document that is opposite the side with the photographic image). The physical credential 100 can include security features, such as a security pattern (for example, a printed pattern comprising a tightly printed pattern of finely divided printed and unprinted areas in close proximity to each other, such as a fine-line printed security pattern as is used in the printing of banknote paper, stock certificates, and the like).

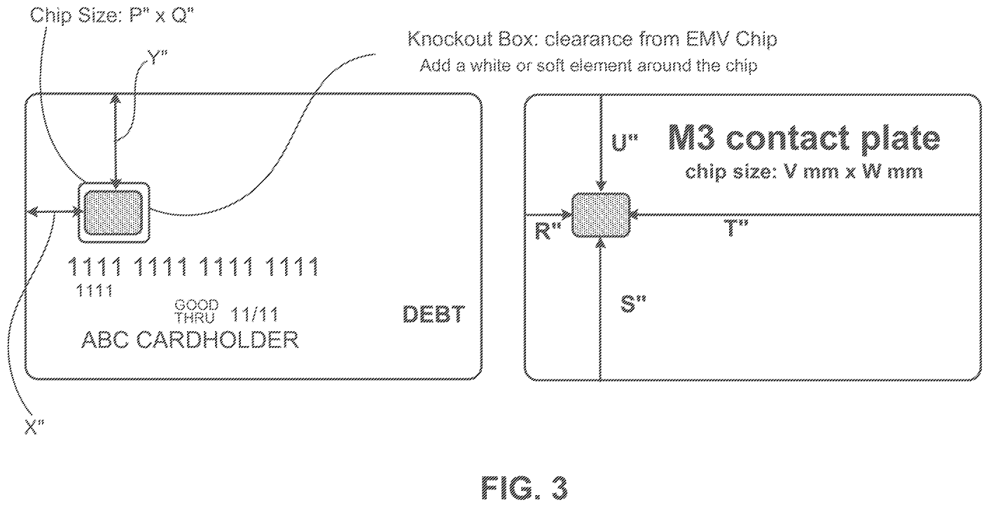

In some embodiments, one or more security attributes 128 can be embedded directly in the core stock layer 104 in compliance with a payment card standard, e.g., EMVco or the Payment Card Industry Data Security Standard (PCI DSS). The payment card standard defines a second architecture defining an arrangement of embedded security attributes 128 in accordance with the X-Y coordinates. For example, the payment card standard and the second architecture can specify that a wire-based antenna can be embedded only within a particular zone defined by particular values of the X-Y coordinates of the physical credential 100. An example second architecture for a payment card standard, e.g., the EMVco payment card standard, is shown in FIG. 3. The core stock layer 104 can be treated (e.g., printed or etched) with security designs or personalization. In some embodiments, designs are printed or etched incorporating line-code technology on either surface of the core stock layer 104 or upon one or multiple edges of the core stock layer 104. Line-code technology refers to imprinting digital signals on a layer of the physical credential 100. The signals can be read by a credential verification system as binary information in a data bitstream.

An inlay card layer 108 is affixed to the core stock layer 104. In some examples, the physical credential 100 is fabricated in a platen lamination process, in which component layers (e.g., layers 104, 108) of the physical credential 100 are fused (affixed) together with heat, pressure, or both, without adhesives. Platen lamination allows the formation of flat cards with little or no thermal stress, as compared to roll lamination that creates stresses by stretching and laminating in a nonuniform manner. Platen lamination also reduces or eliminates surface interactions due to electrical charge and surface non-evenness, thereby improving card transportation in the card printer. One or more of the component layers may be preprinted (e.g., with invariable data). The invariable data may be present as microprint or added in an offset printing process on one of the layers used to construct the card blank.

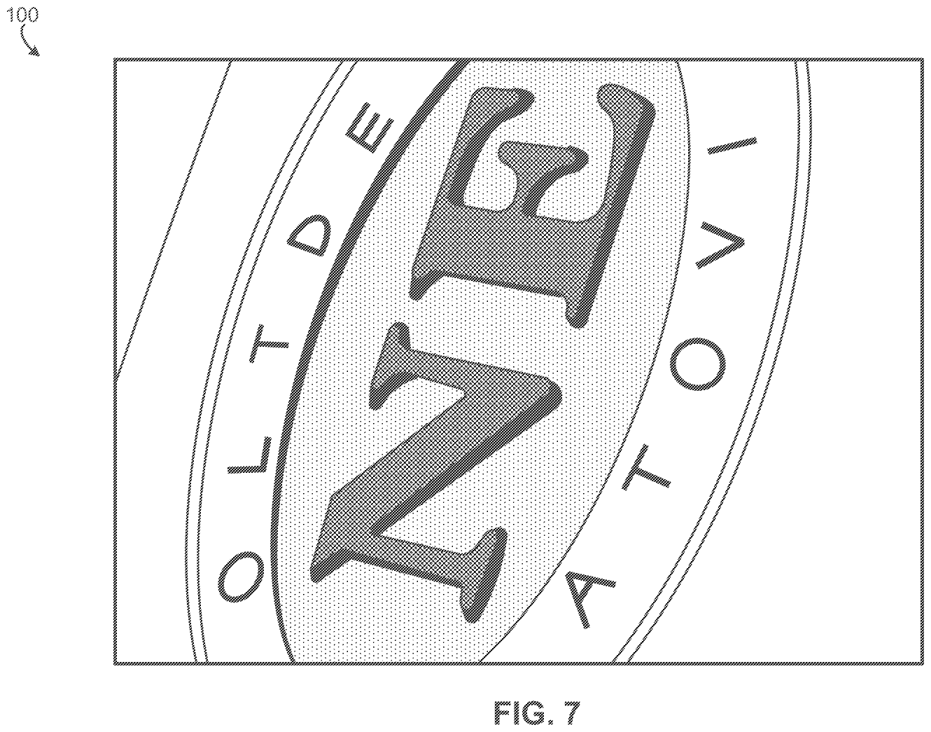

The inlay card layer 108 includes one or more wire-based antennas 124. In some embodiments, the inlay card layer 108 is a contactless dual-interface inlay card layer. A dual-interface inlay card layer can have contact and contactless interfaces. The “contactless” interface means the inlay card layer includes a radio-frequency identification (RFID) chip for making payments using RFID short-range radio communication. The “contact” interface means the physical credential 100 can also be used with physical readers (either using a traditional magnetic stripe or a semiconductor chip). In other embodiments, the one or more wire-based antennas 124 can be machined into the core stock layer 104 itself, e.g., to reduce the complexity of the physical credential 100, manufacturing, and the supply chain. In some embodiments, the one or more wire-based antennas 124 are configured to transmit one or more one or more digital identity tokens stored on the semiconductor chip 136 to an autonomous vehicle using mesh-based communication as described in more detail with reference to FIG. 7.

In some embodiments, the core stock layer 104 and the inlay card layer 108 conform to an identity card standard specifying a first architecture defining an arrangement of embedded the identity attributes 132. For example, the identity card standard can conform to the AAMVA standard or the ISO/IEC 7810 standard. The disclosed embodiments therefore enable adoption of a converged physical credential by addressing the distinct operational standards of different markets (e.g., the EMVco card standard for financial services and the AAMVA card standard for driver's licenses or identity cards) that define physical space utilization on both sides of a physical credential. While the different standards specify how the physical spaces are to be used, the standards do not provide for exclusive use of the spaces nor do the standards contemplate the ability to store or present data that has been physically “stacked” in different layers but with the same X-Y coordinates. Hence, personalization attributes (e.g., identity attributes 132 or security attributes 128) can be embedded in different layers of the physical credential 100. In some embodiments, the personalization attributes can be encoded in a manner that conveys personally identifiable information (PII) or other identity attributes 132 using machine-readable technologies or visible light “shifting” technologies.

A second core stock layer 112 is affixed to the inlay card layer 108 and provisioned in accordance with a second architecture for embedding security attributes 128 with respect to the X-Y coordinates. In some examples, the core stock layer 112 can be made of various materials (e.g., TESLIN-core) and fused polycarbonate structures. For example, implementations can include a laminate and/or coating, articles formed from plastic, glass, metal, fabric, ceramic, or rubber. Other implementations can include man-made materials, such as microporous materials, single phase materials, two phase materials, coated paper, or synthetic paper (e.g., TYVEC, manufactured by DuPont). Other implementations can include foamed polypropylene film (including calcium carbonate foamed polypropylene film), plastic, polycarbonate, poly olefin, polyester, polyethylene terephthalate (PET), PET-G, PET-F, polyvinyl chloride (PVC), or combinations thereof. In some implementations, the core stock layer 112 is formed of a polymeric material that includes oxygen in a backbone of a chemical structure of the material.

The core stock layer 112 can include a smart card (e.g., cards that include one more semiconductor chips, such as memory devices, microprocessors, and microcontrollers), a contact card, a contactless card, a proximity card (e.g., RFID card). The second architecture defines one or more constraints with the first architecture with respect to the X-Y coordinates. The one or more constraints define particular X-Y coordinates where the different card standards (e.g., EMVco, PCI DSS, AAMVA, ISO/IEC 7810 standard, etc.) conflict. For example, when the identity card standard requires a particular identity attribute to be embedded at particular X-Y coordinates but the payment card standard specifies that the particular X-Y coordinates should be free of attributes, the particular identity attribute can be digitized and stored on a laminated layer (e.g., the personalization layer 116) at the particular X-Y coordinates. Further, EMVco contactless card standards can be used to phase out reliance of magnetic stripe storage methods on the physical credential 100. Therefore, the design of the physical credential 100 can benefit from the release of real estate previously retained for magnetic stripes. The manufacturing of the physical credential 100 can similarly include multiple layers of lamination (e.g., personalization layer 116) to store and convey personalized information.

In some embodiments, a metal card substrate or core stock layer 104 is provisioned. A contactless or dual-interface inlay (antenna technology) layer 108 is next provisioned. A core stock layer 112 (including a semiconductor chip 136) is provisioned. One or more supplemental personalization layer materials (e.g., polyester) are provisioned. Card design art can be applied to each personalization layer vis-à-vis consideration of the converged standards. Therefore, personalization data and technologies, both visible and machine-readable, are applied. In terms of credential authentication, multiple enhanced security features (ESF), such as digital watermarking or “line code” can be applied at the personalization process for each layer, such that multiple ESFs per card are produced.

The core stock layer 112 includes a semiconductor chip 136 that is electrically coupled to the one or more wire-based antennas 124. In some embodiments, the semiconductor chip 136 stores one or more digital identity tokens. In other embodiments, the core stock layer 112 itself includes one or more wire-based antennas 124 machined into the core stock layer 112 and configured to transmit one or more of the identity attributes 132 to a credential reader. In some embodiments, the core stock layer 104 further includes a semiconductor chip 120 electrically coupled to the one or more wire-based antennas 124. The core stock layer 104 can thus store one or more digital identity tokens in compliance with the identity card standard (e.g., AAMVA or ISO/IEC 7810 standard).

In some embodiments, the core stock layer 112 conforms to a payment card standard specifying a second architecture defining an arrangement of embedded the security attributes 128. For example, the payment card standard can conform to the EMVco payment card standard, PCI DSS, another payment card standard, or a combination thereof. Government social security agencies that issue a payment card in the form of the physical credential 100 can prevent fraud by providing financial transactions regardless of the source of funds. In some embodiments, the core stock layer 112 can include the security features 128 in accordance with a payment card that defines a polycarbonate base having personalized layers and a contact chip. In other embodiments, the security features 128 are embedded in the personalization layer 116 as shown in FIG. 1. In some embodiments, the PII can be scanned in a contactless manner. Thus the driver's license number is associated with a payment database (e.g., in a grocery store for food stamps).

A personalization layer 116 is affixed to the core stock layer 112. In some embodiments, to improve security and combat counterfeiting, additional layers can be added for secure credentialing. For example, signature panels formed using the processes described herein allow for personalized credentials to be added to the physical credential 100 in a manner that is difficult to reproduce without sophisticated equipment and materials. These personalization features provide additional security measures to identify counterfeit documents by credential verification and authentication systems and increase the difficulty associated with making a forgery. Signature panels generated using the methods described herein may include portraits, text, graphical patterns, images, and the like, and may be printed at different locations on the physical credential 100.

In some embodiments, one or more of the identity attributes 132 are embedded in the personalization layer 116 in compliance with a first architecture and a second architecture. In other embodiments, identity attributes 132 are embedded in the core stock layer 112 or core stock layer 104, for example, by machining the core stock layer 104. In some embodiments, a solid substrate material, such as a form of plastic (e.g., polycarbonate) or a metal (e.g., aluminum) undergoes a personalization process whereby personalized data (e.g., identity attributes 132) is permanently joined with the core stock layer 104. For example, the personalization can be performed directly upon the core stock layer 104 itself in complete or partial form. Complementary materials that themselves have been completely or partially personalized can further be laminated onto the core stock layer 104. The resulting physical credential 100 can be used by an individual to assert themselves, their qualifications, or their privileges. The identity attributes 132 are associated with the credential 100 vis-à-vis the personalization received.

In some embodiments, one or more of the security attributes 128 are embedded in the personalization layer 116 or the core stock layer 112 in compliance with a first architecture and a second architecture. In some embodiments, the personalization layer 116 is affixed to the core stock layer 104. The personalization layer 116 stores a digitized version of one or more of the identity attributes 132 in compliance with an identity card standard, e.g., AAMVA, ISO/IEC 7810 standard, another identity card standard, or a combination thereof. One or more constraints defined by the second architecture with respect to the X-Y coordinates are thus met. The design and manufacture of the physical credential 100 combines the identity attributes 132 relevant to multiple industries into a single physical credential 100. An individual subject's experience is simplified and machine-assist technology is used to verify the physical credential 100 that shares different identity attribute technology such as security features and line code. A “subject” refers to a human user or organization whose personal information is specified by the credential.

In some embodiments, the personalization layer 116 includes data, characters, symbols, codes, graphics, images, or other information or markings, whether human readable or machine readable, that are (or can be) “personal to” or “specific to” a specific cardholder or group of cardholders. Personalized data can include data that is unique to a specific cardholder (such as biometric information, image information, serial numbers, Social Security Numbers, privileges a cardholder may have, etc.), but is not limited to unique data. Personalized data can include some data, such as initials, birthdate, height, weight, eye color, address, etc., that are personal to a specific cardholder but not necessarily unique to that cardholder (for example, other cardholders might share the same personal data, such as birthdate or initials).

In at least some implementations, personal/variable data can include some fixed data, as well. For example, in at least some implementations, personalized data refers to any data that is not pre-printed onto the physical credential 100 in advance. Such personalized data can include both data that is cardholder-specific and data that is common to many cardholders. Variable data can, for example, be printed on an information-bearing layer of the credential 100 using thermal printing ribbons and thermal printheads. Personalized and/or fixed data is also intended to refer to information that is (or can be) cross-linked to other information on the credential 100 or to the credential 100 issuer. For example, personalized data may include a lot number, inventory control number, manufacturing production number, serial number, etc. Such personalized or fixed data can, for example, indicate the lot or batch of material that was used to make the credential 100, what operator and/or manufacturing station made the credential 100 and when, etc.

FIG. 2 illustrates multiple zones of an example identity card standard, in accordance with one or more embodiments. For example, the multiple zones shown in FIG. 2 define a first architecture, described with reference to FIG. 1. The driver's license and identity card standard illustrated with reference to FIG. 2 includes portions of the AAMVA standard and was developed by the Card Design Standard committee made up of jurisdictional and federal government members. The AAMVA identity card standard provides for the design of driver's licenses and identification cards to improve the security of the cards and the level of interoperability among cards issued by all North American jurisdictions.

In FIG. 2, the first architecture specifies a type of data that can be embedded and for what purpose. For example, Zone 1 specifies a type of the credential. In some embodiments, the type includes at least one of a passport, a driver's license, a health card, a payment card, a credit card, a state identification card, a birth certificate, or an educational certificate. Zone 2 specifies digital attributes of the subject. In some embodiments, the attributes specify at least one of a nationality of the subject, a bank account number of the subject, a class of vehicle that the digital credential entitles the subject to operate, or a date of birth of the subject. Zone 3 specifies an image. In some embodiments, the image is a profile photograph or a fingerprint. Zone 4 specifies an icon identifying the issuing authority and is used for security verification. Zone 5 specifies information encoded within a barcode. The information can include identification information of the subject or payment information.

FIG. 3 illustrates elements of an example architecture defining an arrangement of embedded security attributes specified by an example payment card standard, in accordance with one or more attributes. The architecture shown in FIG. 3 is an example of the second architecture introduced and described in more detail with reference to FIG. 1. The architecture conforms to portions of the EMVco payment card standard. The EMVco standard includes provisions for three different sizes of contact chips. The EMVco payment card standard defines similar design considerations to AAMVA or the ISO/IEC 7810 standard, e.g., X-Y placement, keep-out areas, etc. For example, a size of a semiconductor chip embedded in a payment card is specified by the dimensions P and Q shown in FIG. 3. The dimension X specifies a lateral distance of the chip from an edge of the card. Similarly, the dimensions R, S, T, and U specify lateral distances of edges of the chip from respective edges of the card.

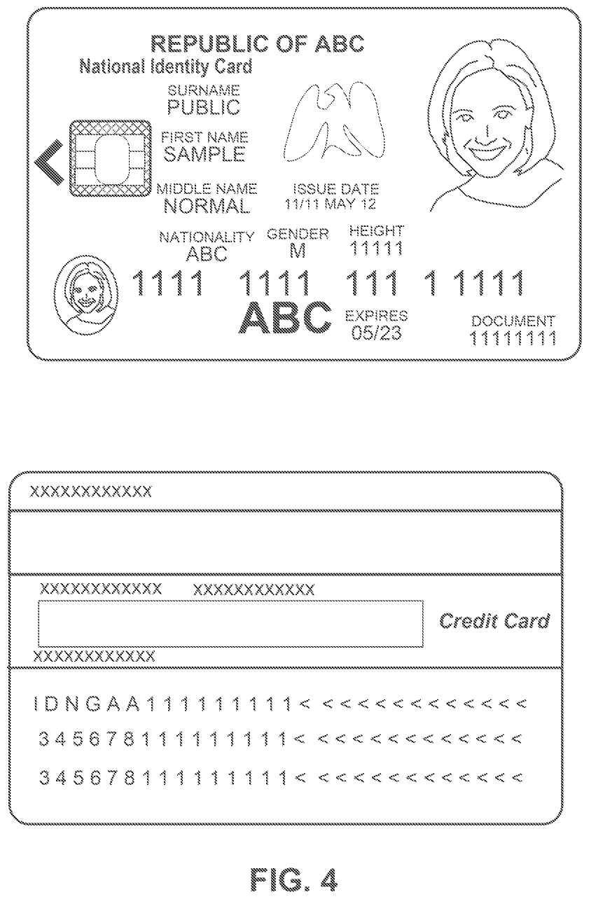

FIG. 4 illustrates an example national identity card converged with a payment card in accordance with an example payment standard for transactions, in accordance with one or more attributes. The national identity card can be used for social-services. The PII of a subject is contained in an embedded semiconductor chip within the national identity card shown in FIG. 4. The semiconductor chip is the same as or similar to the semiconductor chip 136 illustrated and described in more detail with reference to FIG. 4. A magnetic stripe of the example national identity card stores additional identity information that can be used to verify eligibility with various national social eligibility programs. In some embodiments, the data encoded within the example converged national identity card shown in FIG. 4 is digitized and stored as a digital credential, as described in more detail with reference to FIG. 7. For example, the data stored within the digital credential includes a credential identifier specifying a set of converged types of the digital credential. The set of converged types can include a digital credit card and a digital state identification card.

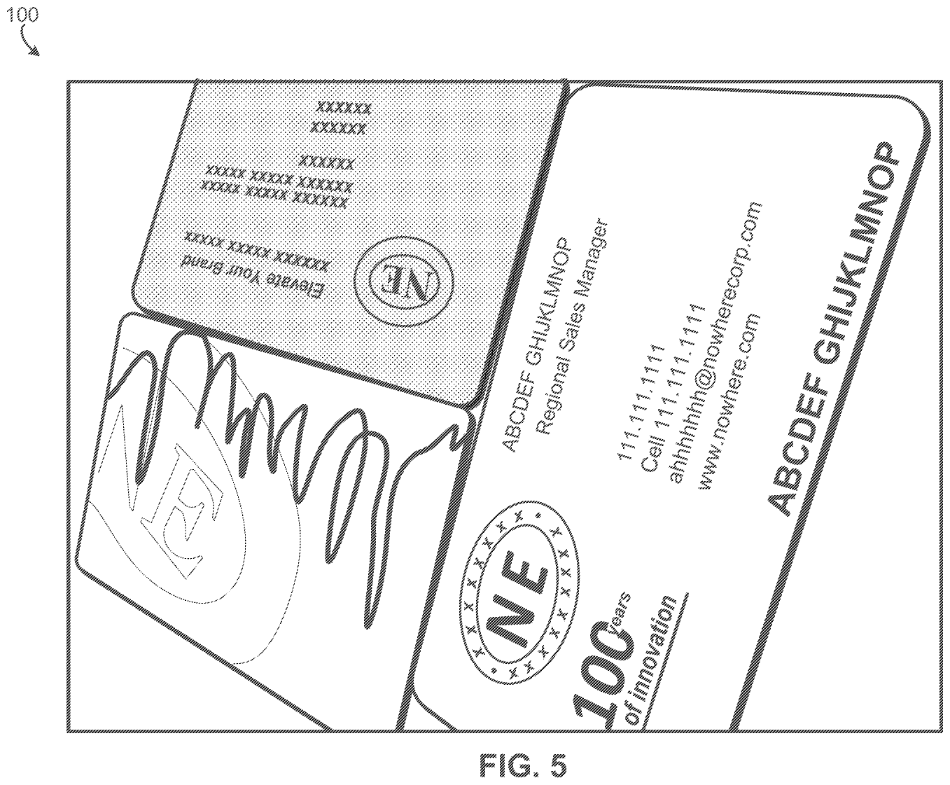

FIG. 5 illustrates an example physical credential 100 comprising a metal core stock layer, in accordance with one or more attributes. The converged physical credential 100 is illustrated and described in more detail with reference to FIG. 1. The metal core stock layer is the same as or similar to the metal core stock layer 112 illustrated and described in more detail with reference to FIG. 1. The physical credential 100 can be used to access a credit card network operated by a bank that is used for state benefit payment processing. The credit card network is used for monitoring and transactions. In some embodiments, the physical credential 100 shown in FIG. 5 is used as a contactless state identity card. A bank can embed the contactless state identity card 100 as a polyester laminate (e.g., a personalization layer) fused to a payment core stock layer. An example personalization layer 116 and payment core stock layer 112 are illustrated and described in more detail with reference to FIG. 1.

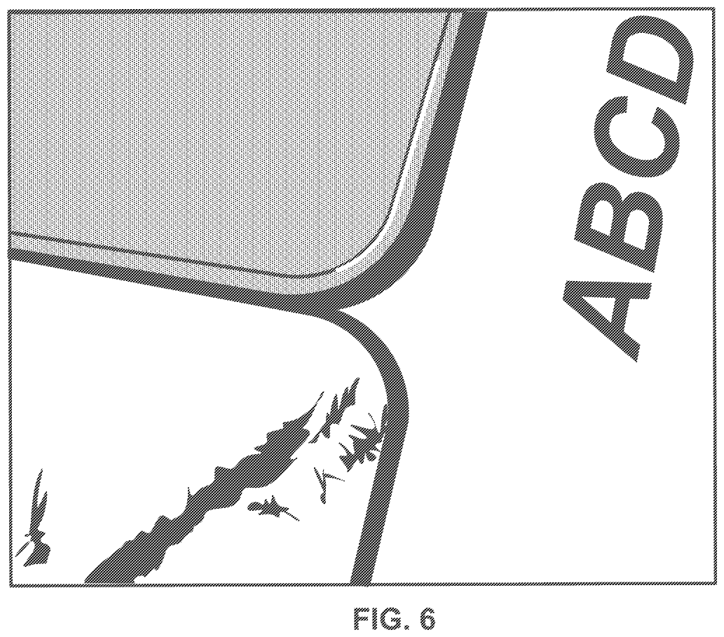

FIG. 6 illustrates an example surface treatment implemented on a metal core stock layer, in accordance with one or more attributes. The metal core stock layer is the same as or similar to the metal core stock layer 112 illustrated and described in more detail with reference to FIG. 1. For example, complex surface treatments can be implemented using metal core layer materials, such as bulk or custom graining, machining, and graining with or without high resolution printing in accordance with ESF technologies, such as digital watermarking and line code.

FIG. 7 illustrates a portion of an example physical credential 100, in accordance with one or more attributes. The physical credential 100 is illustrated and described in more detail with reference to FIG. 1. To manufacture the physical credential 100, a processing sequence can include custom stamping, printing, texturing, or engraving.

In additional embodiments, the physical credential 100 shown in FIG. 7 is readable by an autonomous vehicle. For example, a semiconductor chip 136 of the manufactured physical credential 100 can be read by a scanner, a card reader, or another credential authentication system of an autonomous vehicle. The semiconductor chip 136 is illustrated and described in more detail with reference to FIG. 1. The autonomous vehicle uses information from the physical credential 100 to authenticate and perform on-boarding of the subject of the physical credential 100 as well as process payments for a ride in the autonomous vehicle.

In some embodiments, the physical credential 100 includes one or more radios, and the physical credential 100 is part of a wireless mesh network (WMN) made up of radio nodes organized in a mesh topology, e.g., Zigbee. The WMN includes mesh clients, such as an autonomous vehicle. An autonomous vehicle that is part of the WMN can aggregate digital identity tokens stored by the semiconductor chip 136 with data identifying the autonomous vehicle using mesh network communication. The mesh network communication is based on a protocol, such as associativity-based routing (ABR), ad hoc on-demand distance vector (AODV), the Babel protocol (a distance-vector routing protocol for IPv6 and IPv4 with fast convergence properties), etc. For example, the vehicle identification data and onboard passenger electronic identity credentials can be verified, authenticated, and integrated before a passenger is allowed to board the autonomous vehicle. The autonomous vehicle further uses the identity information of a passenger carrying the physical credential to perform a payment or transaction.

A vehicle identifier number (VIN) is typically affixed to motor vehicles. The purpose of the VIN is to function as a manufactured product serial number that captures the manufacturing date code and specific configuration of the vehicle as originally manufactured. A department of motor vehicles (DMV) can use this number as a unique identifier for purposes of registration and taxation; insurance underwriters use this identifier for purposes of insurance underwriting. In some embodiments, a VIN is stored on a physical credential similar to the 100 illustrated and described in more detail with reference to FIG. 1. The physical credential is embedded in or affixed to an autonomous vehicle. Other data that is embedded in the physical credential can include insurance information for the AV, trip history, etc. The VIN or other identification information is read from the physical credential embedded in the AV without physically reading the VIN tags or other physical markings upon the vehicle body or frame. Insurance coverage thus be similarly immediately accessible. Driver and passenger identity information within a physical driver's license can further be incorporated and read from the embedded PC, for example, if an individual is incapacitated. Law enforcement can use the data to assist with reporting or forensic accident recreation. Moreover, vehicle conditions, road conditions, and weather do not affect documentation activities. The credentials disclosed herein further provide a means by which to automate vehicle and passenger data transmission in situations where physical transportation and movement are in progress.

In some embodiments, the physical credential 100 is used to identify a passenger traveling in an autonomous vehicle. For example, the autonomous vehicle can read the passenger identification information from the 100 and transmit or broadcast it to other vehicles or vehicle-to-infrastructure (V2I) devices. Further, insurance information for the autonomous vehicle can be communicated between vehicles of like capability or to an agency (e.g., law enforcement, insurance commission, or other vehicles). In other embodiments, data can be gathered for forensic purposes in the event of an accident. In yet other embodiments, the movement of autonomous vehicles can be controlled, and telemetry information is communicated amongst vehicles and passengers in a group of autonomous vehicles travelling in close proximity.

The physical credential 100 can be used to converge digital identity documents, insurance documents, and computerized telemetry equipment to create a standards-based “vehicular information payload” that creates a specific data file format whereby various electronic data may be packaged and exchanged as a single stream or data bundle (a standard protocol). A data transmission protocol and mesh network communication standard can be created whereby the autonomous vehicle identity, insurance status, and passenger identity and privilege endorsement can be used together in conjunction with geospatial position system (GPS) data, a standard clock timecode, and origin and destination information. The communication standard is used to convey this information to other vehicles in the vicinity. Transmitting the autonomous vehicle telemetry information to other vehicles in the vicinity allows the other vehicles to adjust their own telemetry as required to ensure safe passage.

In some embodiments, the creation of a wireless mesh network enables compatible vehicles in the vicinity to network and travel in closer proximity as permitted by local traffic regulations. Encryption and privacy protocols can be used to obfuscate PII except in the case of an accident or law enforcement query. The data generated by a group of autonomous vehicles can be sent to a cloud service where non-PII is aggregated to facilitate machine-learning of autonomous vehicle algorithms from vehicle manufacturers seeking to improve their testing models.

In some embodiments, a converged digital credential is generated for a subject by an issuing authority. Here, “subject” refers to a human user or an organizational entity whose identifying information is stored in the digital credential. The digital credential includes a non-transitory computer-readable storage medium, such as data stored on a website, a thumb drive, a hard drive, a PDF file, etc. The non-transitory computer-readable storage medium stores cryptographically-encoded data that is configured to be verifiable by at least one computer processor. The issuing authority of the digital credential encodes the data into an encrypted form, sometimes referred to as “ciphertext.” A computer system belonging to an authorized party is enabled to decipher the ciphertext to access and verify the data stored within the digital credential.

The data stored within the digital credential includes a credential identifier specifying at least one of an issuing authority of the digital credential, an expiry date and time of the digital credential, a set of converged types of the digital credential, or a cryptographic key. In some embodiments, the issuing authority includes at least one of a government body, a national agency, a certification body, a bank, or a corporation. In some embodiments, the set of converged types includes at least two of a digital passport, a digital driver's license, a digital health card, a digital payment card, a digital credit card, a digital state identification card, a digital birth certificate, or a digital educational certificate. The security attributes 128, illustrated and described in more detail with reference to FIG. 1, can be digitized and stored within the digital credential to provide more security. For example, the security attributes in a digital credential can be used for credential validation, e.g., determining whether the digital credential is still “in force,” and whether the endorsements or privileges of the digital credential are still “valid” (unexpired or unrevoked).

The data stored within the digital credential further includes multiple digital identity tokens. Each digital identity token stores one or more digitized attributes of the subject of the digital credential. The identity attributes 132, illustrated and described in more detail with reference to FIG. 1, can be digitized and stored within the digital credential as one or more digitized attributes of the subject. In some embodiments, the one or more digitized attributes specify at least one of a nationality of the subject, a bank account number of the subject, a class of vehicle that the digital credential entitles the subject to operate, or a date of birth of the subject. In some embodiments, the multiple digital identity tokens are associated with a digitized personalization layer of the digital credential. The one or more digitized attributes are stored in compliance with a digital identity card standard on the digitized personalization layer of the digital credential.

The data stored within the digital credential further includes a set of cryptographic keys. Each cryptographic key corresponds to a respective digital identity token. Each cryptographic key is for cryptographic verification of the respective digital identity token by the at least one computer processor. In some embodiments, the digital credential is configured to be readable by an autonomous vehicle using a mesh network communication standard. The multiple digital identity tokens can be aggregated with data identifying the autonomous vehicle. In some embodiments, the data identifying the autonomous vehicle includes at least one of an autonomous vehicle identity, an insurance status, geospatial position system data, a standard clock timecode, or origin and destination information.

In some embodiments, the data stored within the digital credential further includes at least one digital signature. The at least one digital signature includes a hash of the one or more digitized attributes of the subject stored by at least one digital identity token. The hash is encrypted using a respective cryptographic key corresponding to the at least one digital identity token. For example, the digital signature is used to verify the authenticity of the digital credential, providing a layer of validation and security to the data stored in the digital credential. In some embodiments, when the digital credential is signed, a hash of the one or more digitized attributes of the subject stored by at least one digital identity token is generated. The hash is encrypted using a private key of the subject. The encrypted hash and a public key of the subject are combined into the digital signature, which is appended to the digital credential. The digital credential described herein can be used for one or more of the different identity proofing functions (described in more detail with reference to FIG. 1) using the security attributes and identity attributes stored within the credential.

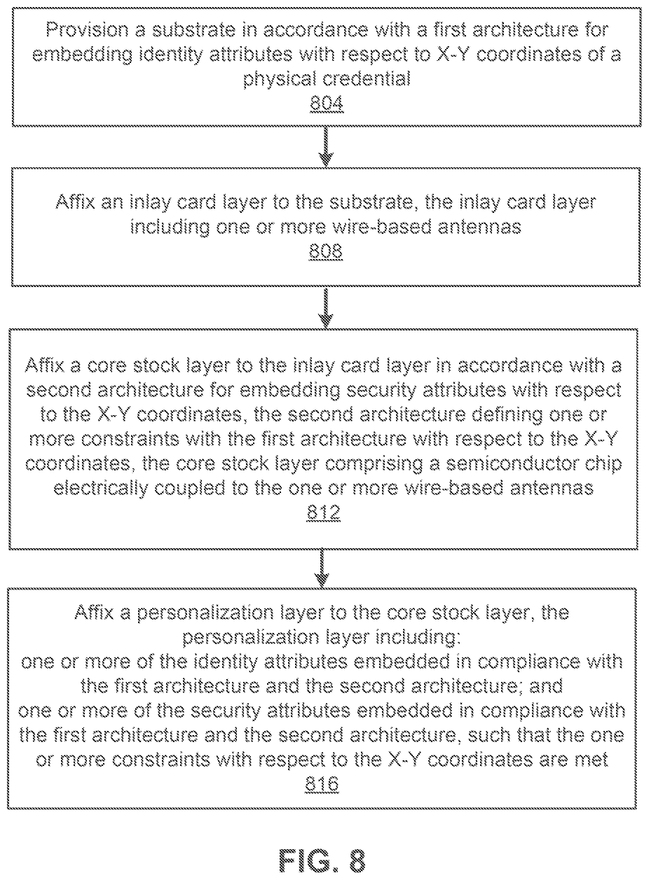

FIG. 8 illustrates an example process for manufacturing a converged physical credential, in accordance with one or more attributes. An example converged physical credential 100 is illustrated and described in more detail with reference to FIG. 1. Embodiments can include different or additional steps, or perform the steps in different orders. In some embodiments, the process of FIG. 8 is performed by a computer system or a special purpose computing device.

A computer system provisions (804) a core stock layer 104 in accordance with a first architecture defining an arrangement of embedded identity attributes 132 with respect to X-Y coordinates of the physical credential 100. The core stock layer 104 and identity attributes 132 are illustrated and described in more detail with reference to FIG. 1. The core stock layer 104 can include polycarbonate, TESLIN, metal, plastic, ceramic, rubber, synthetic paper, polypropylene film, poly olefin, polyester, polyethylene terephthalate, or polyvinyl chloride. When the core stock layer 104 is made of metal, the physical credential 100 can be etched or patterned prior to subsequent personalization and lamination using polyester or newer materials.

The computer system affixes (808) an inlay card layer 108 to the core stock layer 104. The inlay card layer 108 is illustrated and described in more detail with reference to FIG. 1. The inlay card layer 108 includes one or more wire-based antennas 124. The wire-based antennas 124 are illustrated and described in more detail with reference to FIG. 1. In some embodiments, the inlay card layer 108 is a contactless dual-interface inlay card layer. In other embodiments, the one or more wire-based antennas 124 can be machined into the core stock layer 104 itself to reduce the complexity of the physical credential 100, manufacturing, and the supply chain.

The computer system affixes (812) a core stock layer 112 to the inlay card layer 108 in accordance with a second architecture defining an arrangement of embedded security attributes 128 with respect to the X-Y coordinates. The core stock layer 112 and security attributes are illustrated and described in more detail with reference to FIG. 1. The second architecture defines one or more constraints with the first architecture with respect to the X-Y coordinates. The core stock layer 112 includes a semiconductor chip 136 electrically coupled to the one or more wire-based antennas 124. The semiconductor chip 136 is illustrated and described in more detail with reference to FIG. 1.

The computer system affixes (816) a personalization layer 116 to the core stock layer 112. The personalization layer 116 is illustrated and described in more detail with reference to FIG. 1. The personalization layer 116 includes one or more of the identity attributes 132 embedded in compliance with the first architecture and the second architecture. One or more of the security attributes 128 are embedded in compliance with the first architecture and the second architecture, such that the one or more constraints with respect to the X-Y coordinates are met.

A number of implementations have been described. Nevertheless, it will be understood that various modifications can be made without departing from the spirit and scope of the invention. In addition, the logic flows depicted in the figures do not require the particular order shown, or sequential order, to achieve desirable results. In addition, other steps can be provided, or steps can be eliminated, from the described flows, and other components can be added to, or removed from, the described systems. Accordingly, other embodiments are within the scope of the following claims.

What is claimed is:

1. A physical credential comprising:
a first core stock layer provisioned in accordance with a first architecture defining an arrangement of embedded identity attributes with respect to X-Y coordinates of the physical credential;
an inlay card layer affixed to the first core stock layer and comprising one or more wire-based antennas;
a second core stock layer affixed to the inlay card layer and provisioned in accordance with a second architecture defining an arrangement of embedded security attributes with respect to the X-Y coordinates, the second architecture defining one or more constraints with the first architecture with respect to the X-Y coordinates, the second core stock layer comprising a semiconductor chip electrically coupled to the one or more wire-based antennas; and
a personalization layer affixed to the second core stock layer and comprising:
one or more of the identity attributes embedded in compliance with the first architecture and the second architecture; and
one or more of the security attributes embedded in compliance with the first architecture and the second architecture, such that the one or more constraints with respect to the X-Y coordinates are met.

2. The physical credential of claim 1, wherein the first core stock layer comprises at least one of polycarbonate, TESLIN, metal, plastic, ceramic, rubber, synthetic paper, polypropylene film, poly olefin, polyester, polyethylene terephthalate, or polyvinyl chloride.

3. The physical credential of claim 1, wherein the inlay card layer is a contactless dual-interface inlay card layer.

4. The physical credential of claim 1, wherein the first core stock layer and the inlay card conform to an identity card standard defining the first architecture.

5. The physical credential of claim 1, wherein the core stock layer conforms to a payment card standard defining the second architecture.

6. The physical credential of claim 1, wherein the semiconductor chip stores one or more digital identity tokens.

7. The physical credential of claim 1, wherein the one or more wire-based antennas are configured to transmit one or more one or more digital identity tokens stored on the semiconductor chip to an autonomous vehicle.

8. A physical credential comprising:
a core stock layer conforming to an identity card standard, the identity card standard specifying a first architecture defining an arrangement of embedded identity attributes in accordance with X-Y coordinates of the physical credential, the core stock layer comprising:
one or more one or more wire-based antennas machined into the core stock layer and configured to transmit one or more of the identity attributes to a credential reader; and
one or more security attributes embedded in the core stock layer in compliance with a payment card standard, the payment card standard specifying a second architecture defining an arrangement of embedded security attributes in accordance with the X-Y coordinates; and
a personalization layer affixed to the core stock layer and storing a digitized version of the one or more of the identity attributes in compliance with the identity card standard, such that one or more constraints defined by the second architecture with respect to the X-Y coordinates are met.

9. The physical credential of claim 8, wherein the identity attributes comprise at least one of a constrained code attribute, a barcode, a photograph, a magnetic stripe, a radio frequency identifier, a fluorescent overlay, a hologram, microtext, or laser engraving.

10. The physical credential of claim 8, wherein the core stock layer further comprises a semiconductor chip electrically coupled to the one or more wire-based antennas.

11. The physical credential of claim 8, wherein the core stock layer stores one or more digital identity tokens in compliance with the identity card standard.

12. The physical credential of claim 8, wherein the physical credential conforms to at least one of:
a Europay, Mastercard, and Visa Consortium (EMVco) standard;
an American Association of Motor Vehicle Administrators (AAMVA) standard;
an International Standardization Organization (ISO)/International Electrotechnical Commission (IEC) 7810 standard; or
a Payment Card Industry Data Security Standard (PCI DSS).

13. A digital credential comprising:
a non-transitory computer-readable storage medium storing cryptographically-encoded data configured to be verifiable by at least one computer processor, the data comprising:
a credential identifier specifying at least one of an issuing authority of the digital credential, an expiry date and time of the digital credential, a plurality of converged types of the digital credential, or a cryptographic key;
a plurality of digital identity tokens, each digital identity token of the plurality of digital identity tokens storing one or more digitized attributes of a subject of the digital credential; and
a plurality of cryptographic keys, wherein each cryptographic key of the plurality of cryptographic keys corresponds to a respective digital identity token of the plurality of digital identity tokens, and each cryptographic key of the plurality of cryptographic keys is for cryptographic verification of the respective digital identity token by the at least one computer processor.

14. The digital credential of claim 13, wherein the issuing authority comprises at least one of a government body, a national agency, a certification body, a bank, or a corporation.

15. The digital credential of claim 13, wherein the plurality of converged types comprises at least two of a digital passport, a digital driver's license, a digital health card, a digital payment card, a digital credit card, a digital state identification card, a digital birth certificate, or a digital educational certificate.

16. The digital credential of claim 13, wherein the one or more digitized attributes specify at least one of a nationality of the subject, a bank account number of the subject, a class of vehicle that the digital credential entitles the subject to operate, or a date of birth of the subject.

17. The digital credential of claim 13, wherein the digital credential is configured to be readable by an autonomous vehicle using a mesh network communication standard, such that the plurality of digital identity tokens can be aggregated with data identifying the autonomous vehicle.

18. The digital credential of claim 17, wherein the data identifying the autonomous vehicle comprises at least one of an autonomous vehicle identity, an insurance status, geospatial position system data, a standard clock timecode, or origin and destination information.

19. The digital credential of claim 13, wherein the data further comprises at least one digital signature, the at least one digital signature comprising a hash of the one or more digitized attributes of the subject stored by at least one digital identity token of the plurality of digital identity tokens, the hash encrypted using a respective cryptographic key corresponding to the at least one digital identity token.

20. The digital credential of claim 13, wherein the plurality of digital identity tokens is associated with a digitized personalization layer of the digital credential, such that the one or more digitized attributes are stored in compliance with a digital identity card standard.
